(19) United States
(12) Patent Application Publication
(10) Pub. No.: US 2018/0121101 A1
(43) Pub. Date: May 3, 2018

(54) Smart Storage Policy

(71) Applicant: Microsoft Technology Licensing, LLC, Redmond, WA (US)

(72) Inventors: Ravinder S. Thind, Sammamish, WA (US); Eric N. Lee, Seattle, WA (US); Bhavya Kashyap, Seattle, WA (US); Ravisankar V. Pudipeddi, Bellevue, WA (US)

(21) Appl. No.: 15/793,297

(22) Filed: Oct. 25, 2017

Related U.S. Application Data
(60) Provisional application No. 62/414,498, filed on Oct. 28, 2016.

(51) Int. Cl. G06F 3/06

(52) U.S. Cl. CPC G06F 3/0608; G06F 3/0662; G06F 3/067; G06F 3/0614; G06F 3/0604; G06F 3/0655

(57) ABSTRACT

Storage virtualization techniques that automate the management of content between local storage and cloud storage in a manner that is both flexible and user-friendly are disclosed herein. A smart storage policy engine may be configured to detect the occurrence of one or more events relating to a storage capacity of the computing device, determine, in response to the detection, a need to free an amount of storage of the computing device, and execute one or more policies relating to stored content of the computing device.

### CROSS REFERENCE TO RELATED APPLICATIONS

This application claims the benefit of U.S. provisional application No. 62/414,498 filed on Oct. 28, 2016, which is incorporated herein by reference in its entirety.

### BACKGROUND

With the ever increasing need for data storage in computer systems, the use of cloud storage providers is increasing. With cloud storage, the data of a file or directory is stored “in the cloud” rather than on a user's local computing device. When the data for a file or directory is needed, it can be pulled “from the cloud” back onto the user's local computing device. Typically, the user must install cloud provider software on the user's local computing device which manages the storage and retrieval of files to/from the cloud provider service and the syncing of data between the local computing device and the cloud storage. Unfortunately, cloud storage providers do not currently offer the ability to automate the management of content between storage local to the computing device and cloud storage in a manner that is both flexible and user-friendly.

### SUMMARY

Disclosed herein are storage virtualization techniques including smart storage policies implemented by a smart storage policy engine to automate the management of content between storage local to a computing device and cloud storage in a manner that is both flexible and user-friendly. In one embodiment, the smart storage policy engine may be configured to detect the occurrence of one or more events or conditions relating to a storage capacity of the computing device and to determine, in response to the detection, a need to free an amount of storage on the computing device. The smart storage policy engine may be further configured to execute one or more policies relating to stored content of the computing device, each policy specifying an action to be performed on a portion of the stored content based on a type of the stored content and an age of the stored content. The portion of the stored content may comprise content stored on the computing device that exceeds an age threshold specified in the one or more policies, the actions may comprise at least one of deleting the portion of the stored content or moving the portion of stored content to a remote store on a network to which the computing device is connected, and the one or more policies may be executed until the determined amount of storage of the computing device has been freed.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. In the drawings:

FIG. 1 illustrates an exemplary computing device, in which the aspects disclosed herein may be employed;

FIG. 2 illustrates an example architecture for storage virtualization in accordance with one embodiment;

FIGS. 3A, 3B, and 3C illustrate a regular file, placeholder, and reparse point for a file, respectively, in accordance with one embodiment;

FIG. 4 illustrates further details of an architecture for storage virtualization in accordance with one embodiment;

FIG. 5 illustrates an example process of creating a placeholder for a file, in accordance with one embodiment;

FIG. 6 illustrates an example process of accessing file data for a placeholder, in accordance with one embodiment;

FIGS. 7A and 7B illustrates example details of the file data access process of FIG. 6;

FIG. 8 illustrates an example storage virtualization architecture comprising a smart storage policy engine;

FIG. 9 illustrates an example process of the smart storage policy engine implementing one or more smart storage policies;

FIG. 10 illustrates example details of the execution of the smart storage policies by the smart storage policy engine;

FIG. 11 illustrates an example toast sent by the smart storage policy engine to obtain user consent;

FIG. 12 illustrates an example settings page of the smart storage policy engine;

FIG. 13 illustrates example possible entry points and triggers associated with the smart storage policy engine; and

FIG. 14 illustrates an example procedure of the smart storage policy engine analyzing various system components.

### DETAILED DESCRIPTION OF ILLUSTRATIVE EMBODIMENTS

Disclosed herein are techniques that automate the management of content between storage local to a computing device and remote storage in a manner that is both flexible and user-friendly. A smart storage policy engine may be configured to detect the occurrence of one or more events relating to a storage capacity of the computing device, determine, in response to the detection, a need to free an amount of storage of the computing device, and execute one or more smart storage policies relating to stored content of the computing device in order to free the required amount of storage.

### Example Computing Device

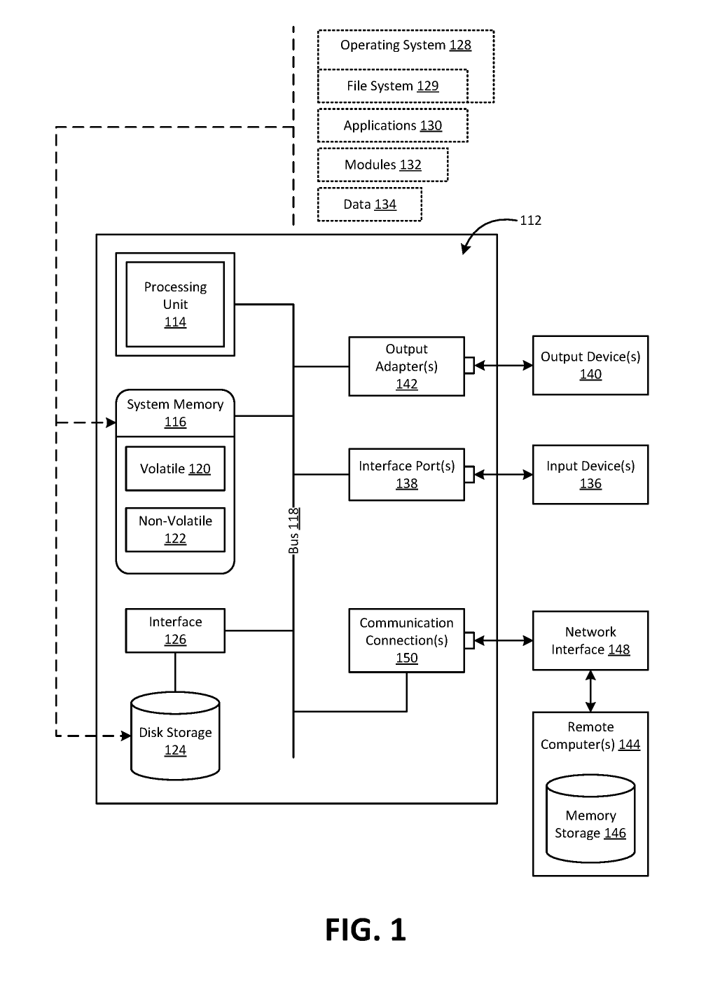

FIG. 1 illustrates an example computing device 112 in which the techniques and solutions disclosed herein may be implemented or embodied. The computing device 112 may be any one of a variety of different types of computing devices, including, but not limited to, a computer, personal computer, server, portable computer, mobile computer, wearable computer, laptop, tablet, personal digital assistant, smartphone, digital camera, or any other machine that performs computations automatically.

The computing device 112 includes a processing unit 114, a system memory 116, and a system bus 118. The system bus 118 couples system components including, but not limited to, the system memory 116 to the processing unit 114. The processing unit 114 may be any of various available processors. Dual microprocessors and other multiprocessor architectures also may be employed as the processing unit 114.

The system bus 118 may be any of several types of bus structure(s) including a memory bus or memory controller, a peripheral bus or external bus, and/or a local bus using any variety of available bus architectures including, but not limited to, Industry Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 116 includes volatile memory 120 and nonvolatile memory 122. The basic input/output system (BIOS), containing the basic routines to transfer information between elements within the computing device 112, such as during start-up, is stored in nonvolatile memory 122. By way of illustration, and not limitation, nonvolatile memory 122 may include read only memory (ROM), programmable ROM (PROM), electrically programmable ROM (EPROM), electrically erasable ROM (EEPROM), or flash memory. Volatile memory 120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computing device 112 also may include removable/non-removable, volatile/non-volatile computer-readable storage media. FIG. 1 illustrates, for example, a disk storage 124. Disk storage 124 includes, but is not limited to, devices like a magnetic disk drive, floppy disk drive, tape drive, Jaz drive, Zip drive, LS-100 drive, memory card (such as an SD memory card), or memory stick. In addition, disk storage 124 may include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 124 to the system bus 118, a removable or non-removable interface is typically used such as interface 126.

FIG. 1 further depicts software that acts as an intermediary between users and the basic computer resources described in the computing device 112. Such software includes an operating system 128. Operating system 128, which may be stored on disk storage 124, acts to control and allocate resources of the computing device 112. Applications 130 take advantage of the management of resources by operating system 128 through program modules 132 and program data 134 stored either in system memory 116 or on disk storage 124. It is to be appreciated that the aspects described herein may be implemented with various operating systems or combinations of operating systems. As further shown, the operating system 128 includes a file system 129 for storing and organizing, on the disk storage 124, computer files and the data they contain to make it easy to find and access them.

A user may enter commands or information into the computing device 112 through input device(s) 136. Input devices 136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 114 through the system bus 118 via interface port(s) 138. Interface port(s) 138 include, for example, a serial port, a parallel port, a game port, and a universal serial bus (USB). Output device(s) 140 use some of the same type of ports as input device(s) 136. Thus, for example, a USB port may be used to provide input to computing device 112, and to output information from computing device 112 to an output device 140. Output adapter 142 is provided to illustrate that there are some output devices 140 like monitors, speakers, and printers, among other output devices 140, which require special adapters. The output adapters 142 include, by way of illustration and not limitation, video and sound cards that provide a means of connection between the output device 140 and the system bus 118. It should be noted that other devices and/or systems of devices provide both input and output capabilities such as remote computer(s) 144.

Computing device 112 may operate in a networked environment using logical connections to one or more remote computing devices, such as remote computing device(s) 144. The remote computing device(s) 144 may be a personal computer, a server, a router, a network PC, a workstation, a microprocessor based appliance, a peer device, another computing device identical to the computing device 112, or the like, and typically includes many or all of the elements described relative to computing device 112. For purposes of brevity, only a memory storage device 146 is illustrated with remote computing device(s) 144. Remote computing device(s) 144 is logically connected to computing device 112 through a network interface 148 and then physically connected via communication connection 150. Network interface 148 encompasses communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 150 refers to the hardware/software employed to connect the network interface 148 to the bus 118. While communication connection 150 is shown for illustrative clarity inside computing device 112, it may also be external to computing device 112. The hardware/software necessary for connection to the network interface 148 includes, for exemplary purposes only, internal and external technologies such as modems including regular telephone grade modems, cable modems and DSL modems, ISDN adapters, and Ethernet cards.

As used herein, the terms “component,” “system,” “module,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

### Storage Virtualization

The techniques for automated management of stored content disclosed herein may operation in conjunction with storage virtualization techniques also implement on a local computing device, such as cloud storage or other remote storage techniques.

For purposes of illustration only, described hereinafter is one example implementation of storage virtualization on a local computing device. It is understood that this is just one example storage virtualization implementation and that the techniques for automated storage management disclosed herein may be implemented in conjunction with any storage virtualization techniques or implementations in which stored content on a local computing device is moved to a remote storage location, such as on a network (e.g., “in the cloud”).

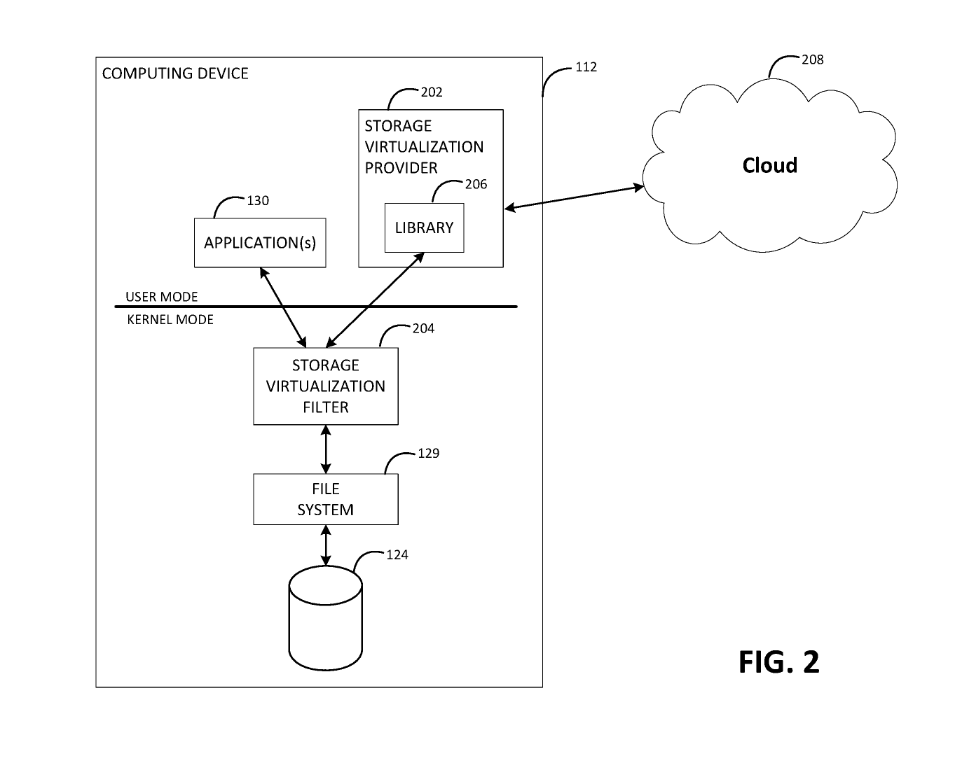

In accordance with the example storage virtualization techniques disclosed herein, a placeholder may be created on a local computing device for a file or directory. The placeholder appears to a user or application as a regular file or directory on the computing device. That is, an application can issue I/O calls on the file or directory as if the file or directory was stored locally, but the placeholder may not contain all the data of the file or directory. FIG. 2 is a block diagram illustrating the components of an architecture for implementing the storage virtualization techniques described herein, in accordance with one embodiment. As shown, in one embodiment, the architecture comprises: a user-mode storage virtualization provider module 202 responsible for retrieving remotely stored file and directory data from a network 208 (e.g., “from the cloud”); a file system filter 204, referred to herein as a storage virtualization filter, that creates and manages placeholders for files and directories and notifies the user-mode storage virtualization provider of access attempts to files or directories whose data is managed by the filter 204 and provider 202; and a user-mode library 206 that abstracts many of the details of provider-filter communication. Note that while the storage virtualization provider 202 runs in user-mode in the illustrated embodiment of FIG. 2, in other embodiments the storage virtualization provider 202 could be a kernel-mode component. The disclosed architecture is not limited to the user-mode embodiment described herein.

In the illustrated embodiment, the user-mode storage virtualization provider module 202 may be implemented (e.g., programmed) by a developer of a remote storage service or entity that provides remote storage services to computing device users. Examples of such remote storage services, sometimes also referred to as cloud storage services, include Microsoft OneDrive and similar services. Thus, there may be multiple different storage virtualization providers, each for a different remote storage service. In the illustrated embodiment, the storage virtualization provider module 202 interfaces with the storage virtualization filter 204 via application programming interfaces (APIs) defined and implemented by the user mode library 206. The storage virtualization provider module 202 implements the intelligence and functionality necessary to store and fetch file or directory data to/from a remote storage location (not shown) on the network 208.

The user-mode library 206 abstracts many of the details of communication between the storage virtualization filter 204 and the storage virtualization provider 202. This may make implementing a storage virtualization provider 202 easier by providing APIs that are simpler and more unified in appearance than calling various file system APIs directly. The APIs are intended to be redistributable and fully documented for third party's to develop storage virtualization providers for their remote storage services. Also, by implementing such a library 206, underlying provider-filter communication interfaces may be changed without breaking application compatibility.

As explained above, the storage virtualization techniques described herein may be applied to both files and directories in a computing device. For ease of illustration only, the operation of these storage virtualization techniques on files is explained herein.

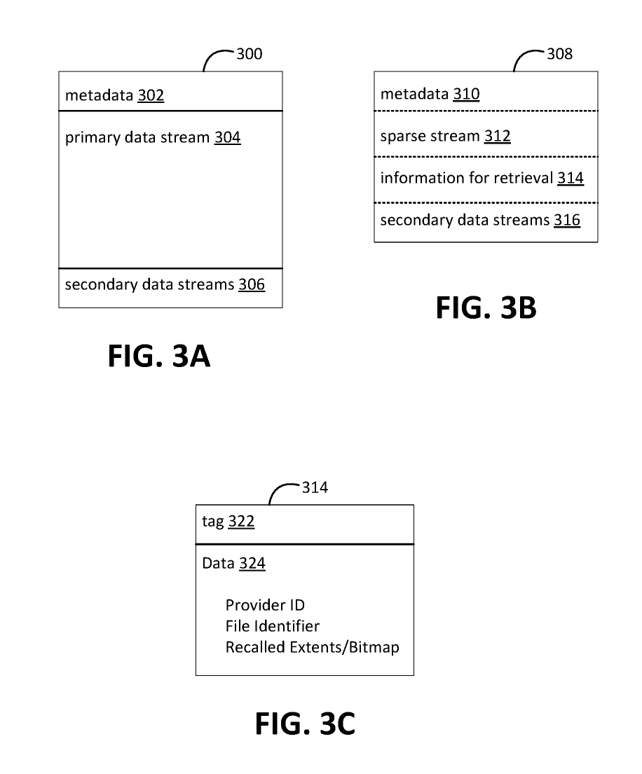

In one embodiment, a file may begin either as a regular file or as a placeholder. FIG. 3A illustrates an example of a regular file 300. As shown, a regular file typically contains metadata 302 about the file (e.g., attributes, time stamps, etc.), a primary data stream 304 that holds the data of the file, and optionally one or more secondary data streams 306. In contrast, as illustrated in FIG. 3B, in one embodiment, a placeholder 308 comprises: metadata 310 for a file, which may be identical to the metadata 302 of a regular file 300; a sparse stream 312 which may contain none or some data of the file (the rest of the data being stored remotely by a remote storage provider); information 314 which enables the remotely stored data for the file to be retrieved; and optionally one or more secondary data streams 316. Because all or some of the data for a file represented by a placeholder 308 is not stored as a primary data stream in the file, the placeholder 308 may consume less space in the local storage of a computing device. Note that a placeholder can at times contain all of the data of the file (for example because all of it was fetched), but as a placeholder, it is still managed by the storage virtualization filter 204 and storage virtualization provider 202 as described herein.

With reference to FIG. 3C, in one embodiment, the information 314 which enables the remotely stored data for the file to be retrieved comprises a reparse point 314. As shown, a reparse point is a data structure comprising a tag 322 and accompanying data 324. The tag 322 is used to associate the reparse point with a particular file system filter in the file system stack of the computing device. In the present embodiment, the tag identifies the reparse point as being associated with the storage virtualization filter 204. In one embodiment, the data 324 of the reparse point 314 may comprise a globally unique identifier (GUID) associated with the storage virtualization provider 202—to identify the storage virtualization provider 202 as the provider for the actual file data for the placeholder. In addition, the data 324 may comprise an identifier of the file itself, such as a file name or other file identifier.

In one embodiment, placeholders do not contain any of the file data. Rather, when there is a request to access the data of a file represented by the placeholder, the storage virtualization filter 204 must work with the storage virtualization provider 202 to fetch all of the file data, effectively restoring the full contents of the file on the local storage medium 124. However, in other embodiments, partial fetches of data are enabled. In these embodiments, some extents of the primary data stream of a file may be stored locally as part of the placeholder, while other extents are stored and managed remotely by the storage virtualization provider 202. In such embodiments, the data 324 of the reparse point of a placeholder may contain an “on-disk” bitmap that identifies chunks of the file that are stored locally versus those that are stored remotely. In one embodiment, the on-disk bitmap comprises a sequence of bits, where each bit represents one 4 KB chunk of the file. In other embodiments, each bit may represent a different size chunk of data. A bit is set if the corresponding chunk is already present in the local storage. As described hereinafter, when a request to read an extent of a file represented by a placeholder is received, the storage virtualization filter 204 examines the on-disk bitmap to determine what parts of the file, if any, are not present on the local storage. For each range of a file that is not present, the storage virtualization filter 204 will then request the virtualization provider 202 to fetch those ranges from the remote storage.

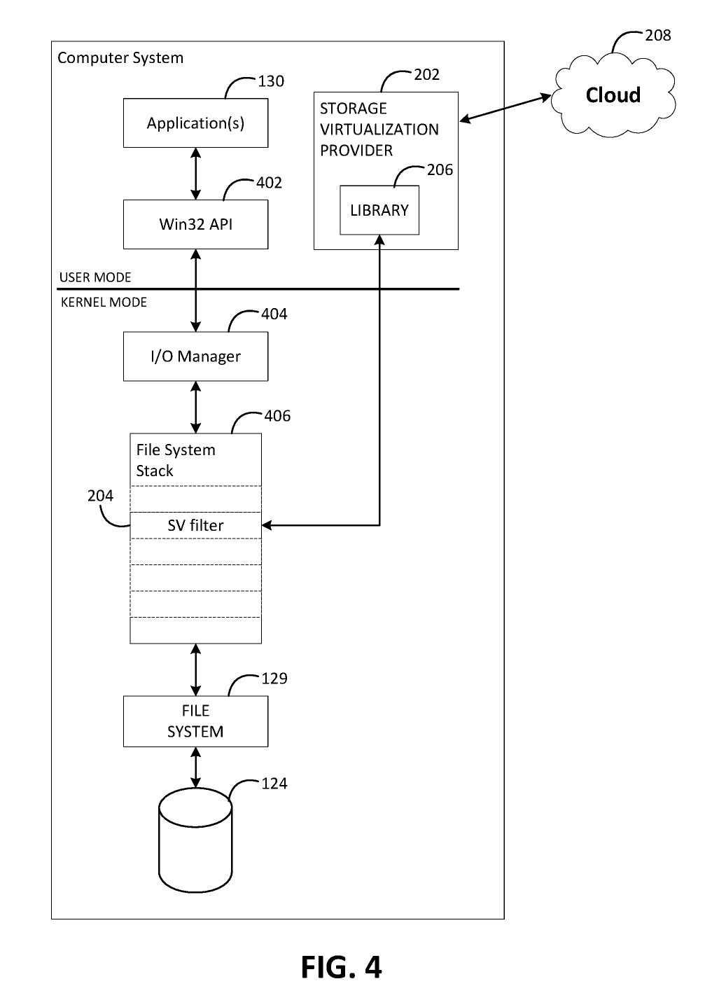

FIG. 4 is a block diagram of the storage virtualization architecture of FIG. 2, as embodied in a computing device that implements the Microsoft Windows operating system and in which the file system 129 comprises the Microsoft NTFS file system. It is understood that the architecture illustrated in FIG. 4 is just one example, and the aspects of the storage virtualization solution described herein are in no way limited to implementation in this example environment. Rather, the aspects disclosed herein may be implemented in any suitable operating system and file system environment.

As shown in FIG. 4, an application 130 may perform file operations (e.g., create, open, read, write) by invoking an appropriate I/O call via the Win32 API 402 of the Windows operating system. These I/O calls will then be passed to an I/O Manager 404 in the kernel space of the operating system. The I/O Manager will pass the I/O call to the file system's stack, which may comprise one or more file system filters. Initially, the call will pass through these filters to the file system 129 itself. In the case of Microsoft's NTFS reparse point technology, if the file system accesses a file on disk 124 that contains a reparse point data structure, the file system will pass the I/O request back up to the stack 406. A file system filter that corresponds to the tag (i.e., globally unique identifier) of the reparse point will recognize the I/O as relating to a file whose access is to be handled by that filter. The filter will process the I/O and then pass the I/O back to the file system for proper handling as facilitated by the filter.

In the case of placeholder files described herein, the file system will pass the I/O request back up the stack to the storage virtualization filter 204, which will handle the I/O request in accordance with the methods described hereinafter.

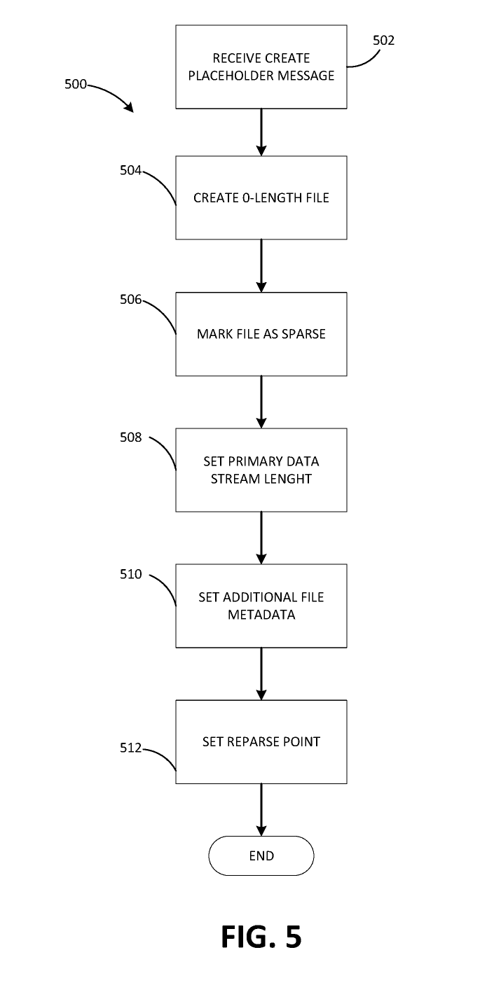

FIG. 5 is a flow diagram illustrating the steps performed by the storage virtualization filter 204 in order to create a placeholder for a file, in accordance with the example architecture illustrated in FIG. 4. The process may be initiated by the storage virtualization provider 202, which may call a CreatePlaceholders function of the user-mode library 206 to do so. The library 206 will, in turn, convert that call into a corresponding CreatePlaceholders message to the storage virtualization filter 204, which will receive that message in step 502 of FIG. 5. Next, in response to the CreatePlaceholders message, the storage virtualization filter 204 will create a 0-length file that serves as the placeholder, as shown at step 504. The CreatePlaceholders message will contain a file name for the placeholder, given by the storage virtualization provider 202. In step 506, the storage virtualization filter 204 will mark the 0-length file as a sparse file. In one embodiment, this may be done by setting an attribute of the metadata of the placeholder. A file that is marked as a sparse file will be recognized by the underlying file system as containing a sparse data set—typically all zeros. The file system will respond by not allocating hard disk drive space to the file (except in regions where it might contain nonzero data).

Continuing with the process illustrated in FIG. 5, in step 508, the storage virtualization filter 204 will set the primary data stream length of the file to a value given by the storage virtualization provider 202 in the CreatePlaceholders message. In step 510, the storage virtualization filter 204 sets any additional metadata for the placeholder file, such as time stamps, access control lists (ACLs), and any other metadata supplied by the storage virtualization provider 202 in the CreatePlaceholders message. Lastly, in step 512, the storage virtualization filter 204 sets the reparse point and stores it in the placeholder file. As described above in connection with FIG. 3C, the reparse point comprises a tag associating it with the storage virtualization filter 204 and data, which may include an identifier of the storage virtualization provider 202 that requested the placeholder, the file name or other file identifier given by the storage virtualization provider 202, and an on-disk bitmap or other data structure that identifies whether the placeholder contains any extents of the file data.

Once creation of the placeholder is completed, the placeholder will appear to a user or application (e.g., application(s) 130) as any other file stored locally on the computing device. That is, the details of the remote storage of the file data is effectively hidden from the applications(s).

In order for an application to issue I/O requests on a file, the application typically must first request the file system to open the file. In the present embodiment, an application will issue a CreateFile call with the OPEN_EXISTING flag set via the Win32 API. This request to open the file will flow down through the file system stack 406 to the file system 129. As described above, in the case of a placeholder file, the file system 129 will detect the presence of the reparse point in the file and will send the request back up the stack 406 where it will be intercepted by the storage virtualization filter 204. The storage virtualization filter 204 will perform operations necessary to open the file and will then reissue the request to the file system 129 in a manner that allows the file system to complete the file open operation. The file system will then return a handle for the opened file to the requesting application. At this point, the application 130 may then issue I/O calls (e.g., read, write, etc.) on the file.

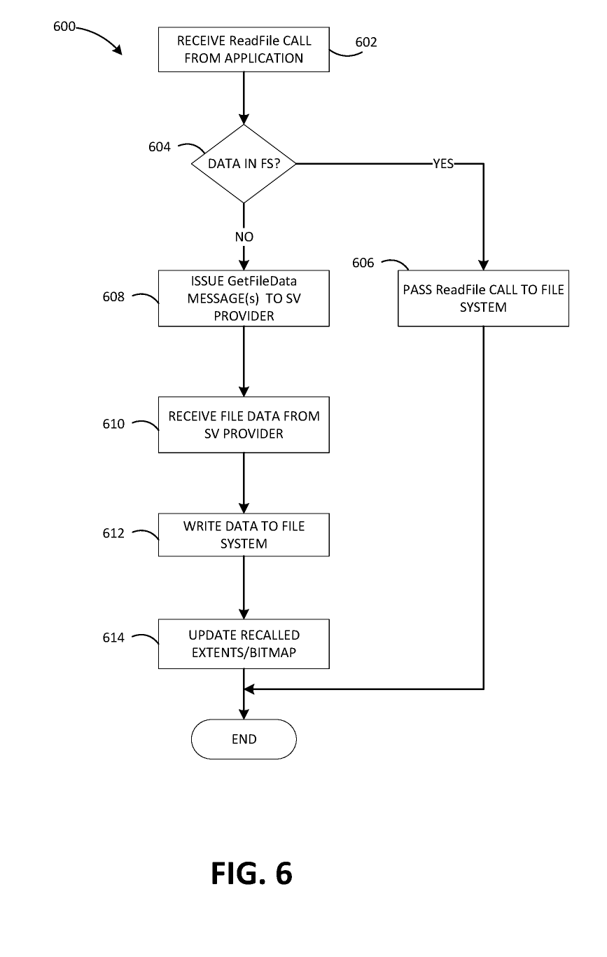

FIG. 6 is a flow diagram illustrating a method for processing an I/O request to read all or a portion of a file represented by a placeholder, in accordance with one embodiment. A request to read a file represented by a placeholder may come from an application 130 via the Win32 API 402 in the form of a ReadFile call. As shown, in step 602, the ReadFile call will be received by the storage virtualization filter 204. At step 604, the storage virtualization filter 204 will determine whether the requested range of data for the file is present in the placeholder or whether it is stored remotely by the storage virtualization provider 202. This determination may be made by examining the on-disk bitmap stored as part of the data of the reparse point for the placeholder. If the storage virtualization filter 204 determines that the requested range of data is stored locally (for example, because it was fetched from remote storage in connection with a prior I/O request), then in step 606 the storage virtualization filter 204 will pass the ReadFile call to the file system 129 for normal processing. The file system will then return the data to the requesting application.

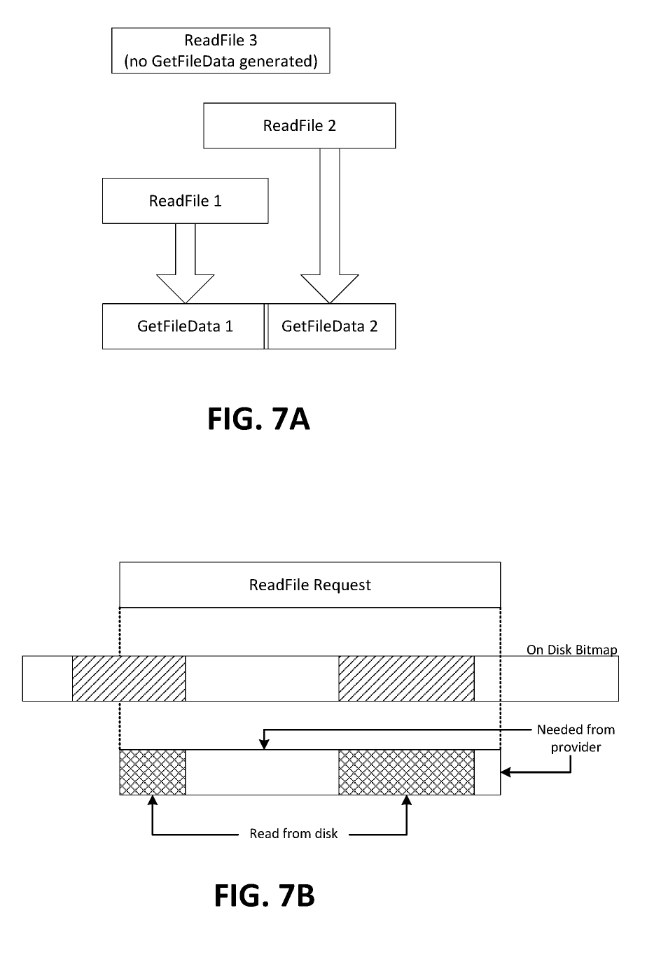

If all or some of the data is not present in the local storage, then in step 608 the storage virtualization filter 204 must formulate one or more GetFileData requests to the storage virtualization provider 202 to fetch the required data. Reads typically result in partial fetches, while some data-modifying operations may trigger fetching of the full file. Once the desired fetch range is determined, the storage virtualization filter 204 must decide whether to generate a GetFileData request for all, some, or none of the range. Preferably, the filter tries to generate a GetFileData for a particular range only once. So, if an earlier GetFileData request is outstanding, and another operation arrives whose requested range overlaps the outstanding GetFileData request, the filter 204 will trim the range needed by the second operation so that its GetFileData request to the provider 202 does not overlap the previous request. This trimming may result in no GetFileData request at all. FIG. 7A illustrates this functionality.

As shown in FIG. 7A, a second ReadFile request (“ReadFile 2”) overlaps a prior request (“ReadFile 1”). So, the storage virtualization filter 204 trims the request range of the GetFileData request that it generates to the storage virtualization provider 202. A third ReadFile request (“ReadFile 3”) is fully encompassed by the two prior requests, so there is no need for the filter 204 to fetch data to satisfy that request. All the data requested by ReadFile 3 will have already been fetched in response to the previous two requests.

As illustrated in FIG. 7B, the storage virtualization filter 204 may determine which ranges of file data need to be requested from the storage virtualization provider 202 by examining the on-disk bitmap that, in one embodiment, is maintained as part of the data of the reparse point of the placeholder. The bitmap is depicted as the middle rectangle in the diagram. Ranges of the file that are already stored on disk are indicated by the hatched spaces in the bitmap. As mentioned above, each bit of the bitmap may indicate the status of a corresponding range (e.g., each bit may represent a corresponding 4 KB range) of the file represented by the placeholder. As illustrated in FIG. 7B, after examining the bitmap, the storage virtualization filter 204 is able to determine which data can be read from disk and which data is needed from the storage virtualization provider 202. The bottom rectangle illustrates the result of comparing the ReadFile request with the on-disk bitmap. The regions the filter will read from disk are indicated, as are the regions the filter will need to obtain from the provider 202.

In one embodiment, the storage virtualization filter 204 may also maintain a tree of in-flight GetFileData requests for each file. Each entry in the tree records the offset and length of data the filter has requested from the provider and not yet received. The tree may be indexed by the file offset. For each region the filter 204 determines is not yet present, the filter 204 may consult the in-flight tree to determine whether any of the regions it may need have already been requested. This may result in further splitting of the GetFileData requests. Once the filter has determined the final set of GetFileData requests it needs to send, it may insert the GetFileData requests into the in-flight tree and sends them to the provider 202.

Referring again to FIG. 6, the storage virtualization filter 204 will issue any necessary GetFileData requests to the storage virtualization provider 202 in step 608. Upon receipt, the user-mode library incorporated in the storage virtualization provider 202 will invoke a corresponding GetFileData callback function implemented by the storage virtualization provider 202. The storage virtualization provider 202 will then perform operations necessary to retrieve the requested data from remote storage on the network. The storage virtualization provider 202 will then return the data to the library 206, and in step 610, the requested file data is returned to the storage virtualization filter 204. At this point, there are two alternatives.

In one alternative, the storage virtualization filter issues a WriteFile request to the file system 129 requesting that the fetched data be written to the sparse data stream of the placeholder. Then, in step 614, the storage virtualization filter 204 will update the on-disk bitmap to indicate that the particular range(s) of data now resides on disk. Note that in one embodiment, the storage virtualization filter 204 makes a distinction between unmodified resident data and modified resident data, and this distinction can potentially help with differential syncing of resident and remote data.

Alternatively, in accordance with another feature of the storage virtualization solution described herein, instead of writing the fetched data to disk, the storage virtualization filter 204 may return the requested data to the application 130 directly, without storing the data on disk. This may be advantageous in situations where disk space is already limited. This feature may also be used to implement a form of data streaming from the remote storage to the requesting application.

According to another aspect of the storage virtualization techniques described herein, the storage virtualization filter 204 may also initiate and manage the conversion of a regular file to a placeholder. During this process, a placeholder will be created for the file as described above, and the data of the primary data stream of the regular file will be sent to the storage virtualization provider 202 for remote storage on the network. For ease of description only, the method of converting a regular file to a placeholder and moving its primary data stream data to remote storage may be referred to as “dehydration,” and the method of fetching the remotely stored data of a placeholder from remote storage and writing it back to disk may be referred to as “hydration.”

According to another aspect, a new “in-sync” attribute may be added to the attributes of a placeholder. The in-sync attribute may be cleared by the storage virtualization filter 204 to indicate when some content or state of a placeholder file has been modified, so that the storage virtualization filter 204 and storage virtualization provider 202 may know that a synchronization should be performed. The in-sync attribute may be set by the storage virtualization provider 202 after it has fully retrieved the file content from the remote storage.

According to yet another aspect, a new “pinned” attribute may be added to the attributes of a file. This attribute may be set by an application to indicate to the storage virtualization filter 204 that the file should not be converted to a placeholder. For example, the storage virtualization filter 204 may be instructed automatically to convert files to placeholders as disk space falls below a certain threshold. But in the case of a file whose pinned attribute has been set, the storage virtualization filter 204 would not convert that file to a placeholder during any such attempt to reduce disk usage. This gives users and applications a level of control over conversion of files to placeholders, in the event that it is important to the user or application that the data of a file remain stored locally. Also important is that the user may prefer to reduce the disk usage on the local computer by not having certain placeholder files/directories fully hydrated by default. In this case, the “pinned” attribute may be combined with another new “online-only” attribute to express the user intent of keeping the content online by default and retrieving it on demand.

According to another aspect of the storage virtualization techniques described herein, a method is provided for detecting and addressing excessive hydration of placeholder files. The two critical system resources that any storage virtualization solution needs to manage are disk space and network usage. Applications written for today's PC ecosystem are not aware of the difference between a normal file and a file hosted on a remote endpoint, such as public cloud services. When running unchecked, these applications can potentially cause excessive hydration of the placeholder files resulting in consumption of disk space and network bandwidth that is not expected by the end user; worse still they might destabilize the operating system to a point that critical system activities are blocked due to low disk/network resources. As used herein, the existence of excessive hydration of placeholder files may be referred to as “runaway hydration.” Exemplary applications that may cause runaway hydration are search indexer, anti-virus, and media applications.

In various embodiments, detecting runaway hydration can be performed in a few different ways. At the minimum, the computing system can choose a static approach of reserving either a fix amount or a percentage of the disk/network resources for critical operating system activities. A baseline of compatible and/or incompatible applications can also be established a priori, with or without user's help. The system can then regulate the resource utilization on a per-application basis. Additionally, known incompatible applications can be modified at runtime via various mechanisms such as an AppCompat engine such that their behavior changes when working with placeholders. However, static approaches like the aforementioned may not be able to scale up to address all the legacy applications in the current PC ecosystem. Therefore, it may be desired to be able to detect runaway hydration at runtime and mitigate it early on. A good heuristic and starting point for detecting runaway hydration at runtime is by monitoring bursts of hydration activities that span across multiple placeholders simultaneously or within a very short period of time. The access pattern on placeholders can be obtained by monitoring all requests to the placeholders in the file system stack or network usage by sync providers or both. Note that the heuristic alone may not be sufficient nor accurate enough in detecting runaway hydration in all cases. User intention may need to be taken into account as well to help differentiate a real runaway hydration case from a legitimate mass hydration case that is either initiated or blessed by the user. It may be effective and efficient to allow the user to participate in the runaway hydration detection but at the same time not overwhelm the user with all trivial popups.

According to further aspects of the runaway hydration detection and remediation concepts disclosed herein, a number of options exist after identifying runaway hydration. From disk space's perspective, the system may choose to continue serving the IO requests on the placeholders but not cache the returned data on the local disk. This is a form of streaming, as discussed above. Another option, which may be referred to as “Smart Policies”, is for the system to dehydrate oldest cached data either periodically or when disk space is urgently required. Extra information, such as last access time, file in-sync state, and user intention/consent, etc., could be tracked/acquired in order for “Smart Policies” to maintain free disk space at a healthy level all the time. From the network's perspective, a sync provider can start throttling/slowing down the download from the cloud. As the last resort, the system, at the request of the user, can stop serving the requests altogether either for selective applications or globally for all applications.

According to another aspect, a timeout mechanism is provided for GetFileData requests from the storage virtualization filter 204 to the storage virtualization provider 202. For example, when the storage virtualization filter 204 sends a GetFileData request to the storage virtualization provider 202, the storage virtualization provider 202 may fail to respond because there is a bug in the provider's program code, the provider code crashes, the provider is hung, or some other unforeseen error occurs. To avoid having the storage virtualization filter 204 wait forever for a response, a timeout period may be set such that when the timeout period expires before any response is received, the storage virtualization filter 204 will stop waiting for the response and, for example, may send a failure indication back to the calling application 130.

According to yet another aspect, a mechanism is provided for canceling GetFileData requests. By way of background, the I/O system in the Windows operating system supports canceling of I/O requests. As an example, when a ReadFile request comes from an application, and it is taking too long to fetch the data, a user can terminate the application which will cancel all outstanding I/O on that file. In one embodiment of the storage virtualization techniques disclosed herein, the storage virtualization filter 204 “pends” I/Os while waiting for the storage virtualization provider 202 to respond, in a way that supports the I/Os being cancelled.

Timeouts and cancellation support are helpful in the presence of inherently unstable mobile network connections where requests may be delayed or lost. When the storage virtualization filter 204 receives a user request and forwards it to the provider 202 running in the user mode, it may track the request in a global data structure and the amount of the time that has elapsed since the forwarding of the request. If the storage virtualization provider 202 completes the request in time, the tracking is stopped. But if for some reason the request does not get completed by the provider 202 in time, the filter 204 can fail the corresponding user request with an error code indicating timeout. This way the user application does not have to get blocked for an indefinite amount of time. Additionally, the user application may discard a previously issued request at any time using, for example, the standard Win32 CancelIO API and the filter 204 will in turn forward the cancellation request to the provider 202, which can then stop the downloading at user's request.

According to another aspect, in one embodiment, the storage virtualization filter 204 and storage virtualization provider 202 utilize the native security model of the underlying file system 129 when accessing files. For example, in the case of the NTFS file system of the Window operating system, the security model of Windows checks for access when a file is opened. If access is granted, then the storage virtualization filter 204 will know when a read/write request is received that the file system has already authorized accesses. The storage virtualization filter 204 may then fetch the data from the remote storage as needed.

According to yet another aspect, a request priority mechanism may be employed. In the case of the Windows operating system, for example, the urgency of a user I/O request is modeled/expressed as I/O priority in the kernel I/O stack. In one embodiment, the storage virtualization filter 204 may expand the I/O priority concept to the user mode storage virtualization provider 202 such that the user intention is made aware all the way to the provider 202 and the requests are handled properly based on the user intention.

According to another aspect, the storage virtualization filter 204 may support different hydration policies with the option to allow the provider 202 to validate the data downloaded/stored to the local computing device first and return the data to the user application only after the data is determined to be identical to the remotely stored copy. In one embodiment, there may be three different hydration policies—Full Hydration, Full Hydration Without End-to-End (E2E) Validation, and Progressive Hydration Without E2E Validation. Both applications 130 and different storage virtualization providers (e.g., provider 202) can define their global hydration policy. In one embodiment, if not defined, the default hydration policy is Progressive Hydration Without E2E Validation for both applications and providers. Preferably, file hydration policy is determined at file open in accordance with the following example formula: File Hydration Policy=min(App_Hydration_Policy, Prov_Hydration_Policy). For example, Word 2016 may specify the “Full Hydration Without E2E Validation” policy, while the Word document is stored by a cloud service whose hydration policy is set at “Full Hydration.” The final hydration policy on this file will be “Full Hydration Without E2E Validation.” Preferably, hydration policy cannot be changed after a file is opened.

### Smart Storage Policy

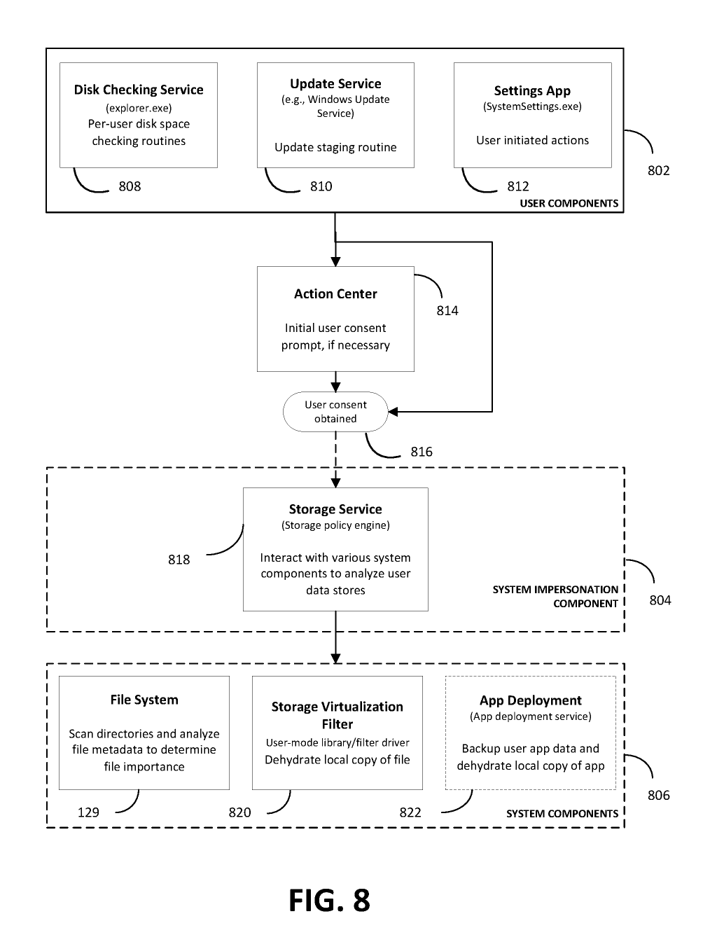

FIG. 8 is a block diagram illustrating example components of an architecture for implementing the smart storage policies discussed herein. As shown, in one embodiment, the architecture may comprise user components 802, a system impersonation component 804, and system components 806. The user components 802 may further comprise: a disk checking service module 808 configured to perform per-user disk space checking routines, an update service module 810 such as a Windows update service configured to perform update staging routines, and a settings app 812 configured to allow a user of the smart storage policy engine to access user-specific settings, make changes to those settings and run storage policies at a certain time, as discussed further below. Note that while the disk checking service module 808, the update service module 810, and the settings app 812 run in the user-mode in the illustrated embodiment of FIG. 8, in other embodiments the modules could be in any of the three components illustrated in FIG. 8.

The architecture may further comprise an action center module 814 configured to prompt the user to obtain user consent 816 to perform smart storage policy operations, as discussed further below.

The system impersonation component 804 may further comprise a storage service module 818. The storage service module 818 may comprise the smart storage policy engine and may be configured to interact with various system components to analyze user data stores.

The system components 806 may further comprise a file system module 129 configured to scan directories and analyze file metadata to determine file importance, such as the file system module shown in connection with FIGS. 1, 2 and 4. The system components 806 may further comprise a storage virtualization filter 820 configured to dehydrate local copies of files to remote storage and an app deployment module 822 configured to backup user app data and dehydrate local copies of apps.

The smart storage policies disclosed herein may comprise instructions for automatically moving content stored locally on a computing device to remote storage (e.g., cloud storage) based on a determination that local storage available on the computing device has fallen below a storage threshold specified in the one or more policies. For example, the storage virtualization implementation described above and illustrated in FIGS. 2-7 may be employed for this purpose. The term “stored content,” or simply “content,” as used herein may refer to any of data or applications stored locally on the computing device. For example, applications that have not been launched in a long period of time may have their data backed up to the cloud (for future restoration) and the application may be dehydrated. This may mean that the application icon would still be visible, but attempting to launch the app would trigger a re-download of the application and associated data. It is understood that the architecture illustrated in FIG. 8 is just one example, and the aspects of the smart storage policy engine architectures described herein are in no way limited to implementation in this example environment. Rather, the aspects disclosed herein may be implemented in any suitable operating system and file system environment.

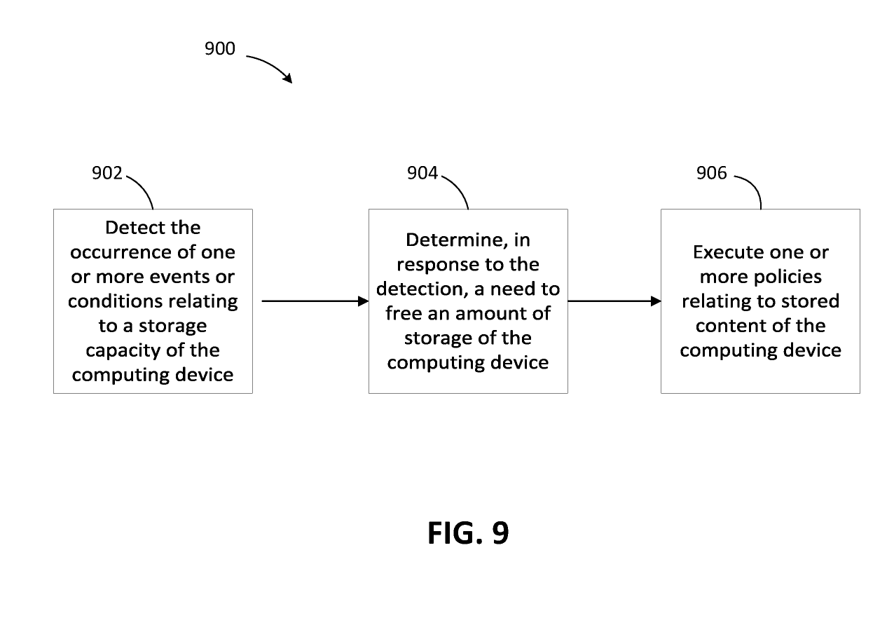

FIG. 9 is an example flow diagram illustrating a high-level process for implementing smart storage policies via the smart storage policy engine. As shown at step 902, the smart storage policy engine may be configured to detect the occurrence of one or more events or conditions relating to a storage capacity of the computing device. In one example, detecting the occurrence of one or more events or conditions relating to a storage capacity of the computing device may comprise determining, in response to a routine disk space checking, that the device has entered a low storage state. A storage threshold for determining that the device has entered a low storage state may be defined in the one or more policies, or may be set by a user of the computing device. In another example, detecting the occurrence of one or more events or conditions may comprise determining, in response to an upgrade request at the computing device, that the device lacks a storage capacity to perform the upgrade successfully. In another example, detecting the occurrence of one or more events or conditions may comprise detecting a request by a user that the one or more storage policies be executed at a specified time or that a specified amount of storage be freed.

In response to the one or more detected events or conditions, as shown at step 904 of FIG. 9, the smart storage policy engine may determine a need to free an amount of storage of the computing device. Determining an amount of storage may comprise determining a storage threshold (e.g., 2 GB) that should remain available on the computing device. This threshold may be determined by the smart storage policy engine or may be specified by a user of the computing device. In one example, the policy engine may determine during routine disk space checking that the amount of available storage capacity on the device has fallen below the storage threshold (e.g., 2 GB) and may implement the smart storage policies until the amount of available storage capacity is back above the threshold, as discussed below.

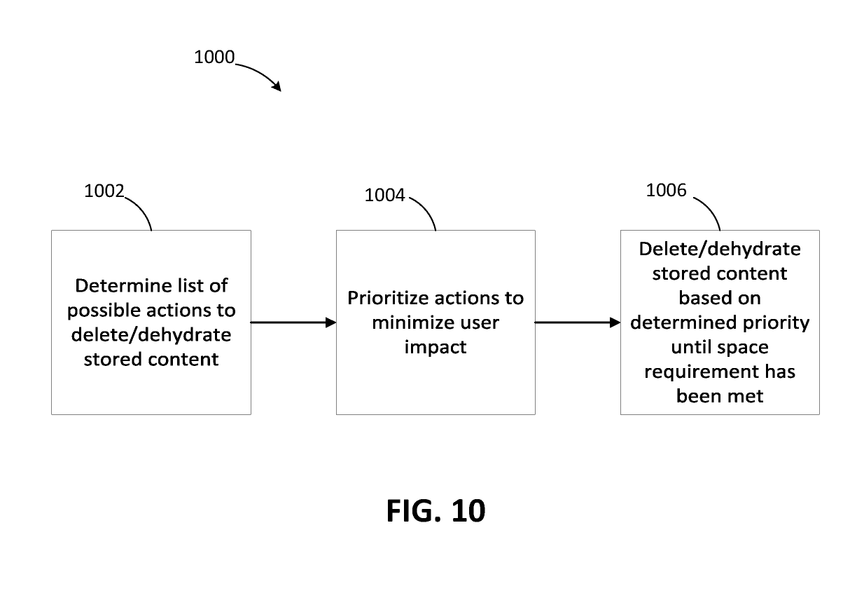

Finally, as shown in step 906, the smart storage policy engine may execute one or more policies relating to stored content of the computing device. Each of the policies may specify an action to be performed on at least a portion of the stored content based on a type of the stored content and an age of the stored content. For example, one policy may specify that content stored in the Recycle Bin for more than one month may be deleted, while another policy may specify that content stored on the local drive for more than six months may be dehydrated (i.e., moved) to external storage. The portion of the stored content may comprise content stored on the computing device that exceeds an age threshold specified in the one or more policies, as discussed further below in connection with FIG. 10. The action may comprise at least one of deleting the stored content or moving the stored content to a remote store on a network to which the computing device is connected, and the one or more policies may be executed until the determined amount of storage of the computing device has been freed. The policies may be configurable, such as by a user or administrator, or in one or more aspects they may be predefined. For example, an age threshold associated with each different type of content may be user selectable.

FIG. 10 illustrates an exemplary procedure for executing the one or more storage policies as shown, for example, in step 906 of FIG. 9. As shown in step 1002 of FIG. 10, the smart storage policy engine may be configured to determine a list of possible actions to delete or dehydrate content stored locally on the device. Determining a list of possible actions may further comprise detecting an age threshold specified in the one or more storage policies for different types of content. An age threshold may comprise a minimum amount of time that content has been stored on the local drive before it is considered by the policy engine for deletion or dehydration to the cloud, and may be determined by the smart storage policy engine or specified by a user. For example, the smart storage policy engine may determine that a first portion of the content has a first age threshold and a second portion of the content has a second age threshold. In addition, the smart storage policy engine may determine that a first portion of the content is associated with a first storage policy while a second portion of the content is associated with a second storage policy. Thus, the smart storage policy engine may be configured to determine that the first action should be performed on the first portion of the content only if the first portion of the content has exceeded the first age threshold, in accordance with the first storage policy, and that the second action should be performed on the second portion of the content only if the second portion of the content has exceeded the second age threshold, in accordance with the second storage policy.

Next, after determining the list of possible actions to delete or dehydrate content stored locally on the device, the policy engine may be configured to prioritize the actions to minimize user impact, as shown in step 1004 of FIG. 10. For example, the smart storage policy engine may be configured to prioritize actions based on a last access time of the file, the content type of the file, or the specific folder path of the file, as discussed further below. For example, the smart storage policy engine may be configured to determine that the first action to be performed on the first portion of the content may be a “high priority” action and the second action to be performed on the second portion of the content may be a “low priority” action, as discussed further below.

Finally, as shown at step 1006, the policy engine may be configured to delete or dehydrate the stored content based on the determined priority until the space requirement has been met. Using the example above, the smart storage policy engine may, in response to determining the list of possible actions and prioritizing the list of actions, first delete or dehydrate any content that has been designated as “high priority” in accordance with the applicable storage policy. If, after deleting or dehydrating the high priority data, the policy engine determines that the amount of available storage has still not reached the storage threshold, the policy engine may continue to delete or dehydrate content that has been given a lower priority until the amount of available storage reaches that threshold.

In one embodiment, as discussed above in connection with FIG. 10, the smart storage policy engine may be configured to prioritize the actions based on a last access time of the content stored on the computing device. For example, in order to minimize user impact, the policy engine may determine that content that has been accessed recently may be more important to the user than content that has not been accessed for a longer period of time, and may choose to prioritize the less important content to be deleted or dehydrated before the more important content. Prioritizing the content may comprise classifying the content into one or more groups. In accordance with these classifications, content which has been accessed more recently (e.g., more important content) may be classified as “low priority,” whereas content that has not been accessed for a longer period (e.g., less important content) may be classified as “high priority.” For example, the computing device may comprise a first portion of content that has not been accessed in one year, a second portion of content that was last accessed six months ago and a third portion of the content that was accessed two weeks ago. The policy engine may classify the first portion of the content as “high priority,” the second portion of the content as “low priority,” and the third portion of the content may not be classified at all since it does not meet the age threshold specified in the one or more policies, and thus will remain on the local storage of the computing device.

Using the example above, when the smart storage policies are executed, for example, when the available storage capacity of the device falls below the storage threshold specified in the one or more policies, the first portion of the content will be deleted or dehydrated to the cloud. If, after the first portion of the content was deleted or dehydrated to the cloud, the available storage is greater than the storage threshold, the smart storage policy engine may stop executing the one or more policies. If, however, the available storage is still less than the threshold, the smart storage policy engine may delete or dehydrate the second portion of the content. If, after deleting or dehydrating the second portion of the content, the amount of available storage is still below the storage threshold, the policy engine may continue to delete or dehydrate content stored on the computing device until the threshold has been exceeded or there is no more content left to delete or dehydrate. The policy engine is not limited to the “high priority” and “low priority” classifications listed above. The policy engine may have only one classification, or may use any number of classifications in order to limit user impact of the storage policy execution process.

In another embodiment, the smart storage policy engine may be configured to delete or dehydrate content from the computing device based on the content type. For example, the smart storage policy engine may classify certain types of content as being less important (e.g., “high priority”) than certain other types of content. This may further include classifying certain types of content in a group that should never be deleted or dehydrated from local storage. For example, the smart storage policy engine may determine that Word documents should be classified as “low priority” while PDF files should be classified as “high priority.” When the policy engine executes the one or more storage policies, for example, when the storage available on the computing device falls below the storage threshold, the PDF files may be dehydrated to the cloud before any of the Word documents.

In yet another embodiment, the smart storage policy engine may be configured to delete or dehydrate files from local storage based on a folder path of the content. For example, the smart storage policy engine may be configured to classify all content in Folder A as being of “low priority” (e.g., more important) and all content in Folder B as being of “high priority” (e.g., less important). When the policy engine executes the one or more storage policies, content in Folder B may be dehydrated to the cloud before content in Folder A.

The smart storage policy engine may be configured to view all storage virtualization providers (e.g., cloud providers) as a single pool of remote storage. For example, if the computing device is associated with multiple cloud providers, the smart storage policy engine may be configured to treat them equally and dehydrate the least valuable content across all of the cloud providers. The user's age-out preferences may apply to all cloud providers, and the policy engine may request to dehydrate any viable candidate files to any of the providers.

Alternatively, the smart storage policy engine may be configured to dehydrate content stored locally on the computing device among different cloud providers based on the characteristics of each cloud provider. The policy engine may be configured to analyze usage across multiple cloud providers and create a single set of files. The file that has not been used for the longest period of time, regardless of what cloud provider it is stored on, may be assigned the highest priority. For example, if the computing device is associated with two cloud providers OneDrive-Personal and OneDrive-Business, with content across each of the providers, but the OneDrive-Personal content has never been accessed and the OneDrive-Business content is accessed on a regular basis, the policy engine may be configured to dehydrate content to the OneDrive-Personal before it attempts to dehydrate content to the OneDrive-Business.

The classification schemes discussed above may be combined in numerous ways, for example, based on a combination of the last access time and the content type, the content type and the specific folders, or the last access time and the specific folders. For example, a first storage policy may specify that any content stored locally on the computing device may be dehydrated to the cloud after six months. However, a second storage policy may specify that certain high priority Content A may be dehydrated after a last access time of three months, and a third storage policy may specify that certain low priority Content B should not be dehydrated until it has a last access time of greater than one year. If the smart storage policy engine is executed, for example, because the amount of available storage has fallen below a storage threshold specified in the one or more policies, content falling in the Content B category that has not been accessed in over three months may be dehydrated first, followed by content not in either of the Content A or Content B categories that has not been accessed in over six months, and finally content falling in the Content A category that has not been accessed in over one year, until the amount of available storage exceeds the threshold specified in the one or more policies.

In another embodiment, all three classification schemes may be combined together. Using the example above, Content A may comprise financial information and may be designated as low priority only for members of an accounting department. Therefore, when the smart storage policy engine executes the one or more smart storage policies, content that falls in the Content B category that has not been accessed in over three months may be dehydrated first. If the computing device that contains Content A is associated with the accounting department, then the content that does not fall in either of Category A or Category B will be dehydrated next, as discussed above. However, if the computing device is not associated with the accounting department, content that falls in the Content A category may be dehydrated along with the rest of the content that does not fall within the Content B category.

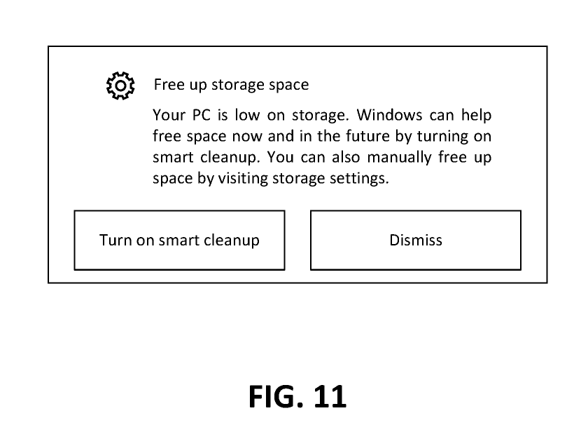

When the smart storage policy engine first detects a low storage state of the computing device and a user of the device has not yet opted in to smart storage policies, an action center toast may be shown to the user. An exemplary toast is shown in FIG. 11. As an example, this toast may fire when the computing device drive has less than MAX(600, 10*\sqrt{total disk size in MB}) free.

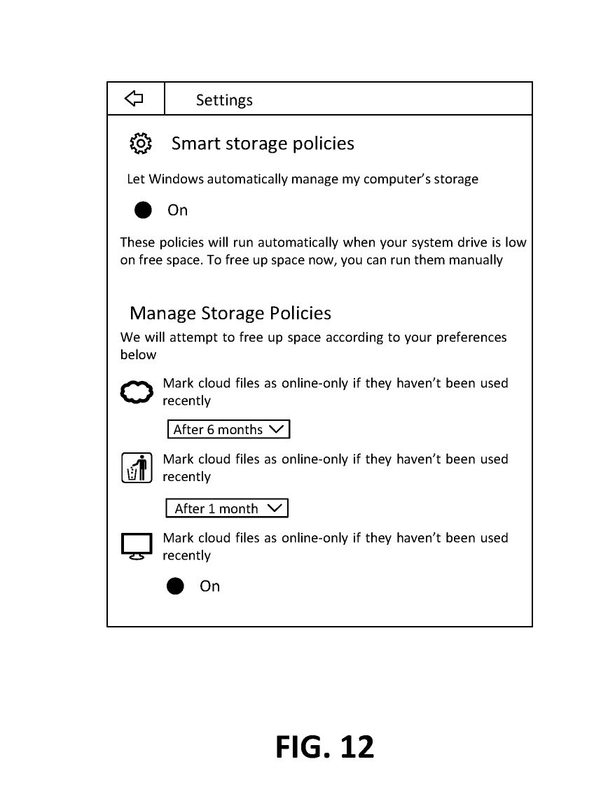

Tapping on the “turn on smart cleanup” button as depicted in FIG. 11 may enable all available smart storage policies and initialize them to default settings. Exemplary default settings are listed below in Table 1. Tapping “Dismiss” may instruct the smart storage policy engine to not perform any action, and the toast may not appear again. Opting to turn on smart cleanup may additionally take a user of the computing device to a Settings landing page, such as that shown in FIG. 12, where they may be able to fine tune or turn off these policies to their preferences. In one embodiment, this page may be visited at any time from a Storage settings page if the user wishes to opt-in or opt-out of the smart storage policies in the future. In one embodiment, user consent is required in order to perform any automatic storage reclamation. However, temporary file cleanup may occur regardless of whether a user has opted into the smart storage policies as it may have no impact on the user data.

TABLE 1
Default Settings

| | Default Value after |
|---|---|
| Policy | initial user consent |
| Cloud files dehydration | After 6 months |
| Recycle bin age-out | After 1 month |
| Temporary file caches | On (After 1 week) |

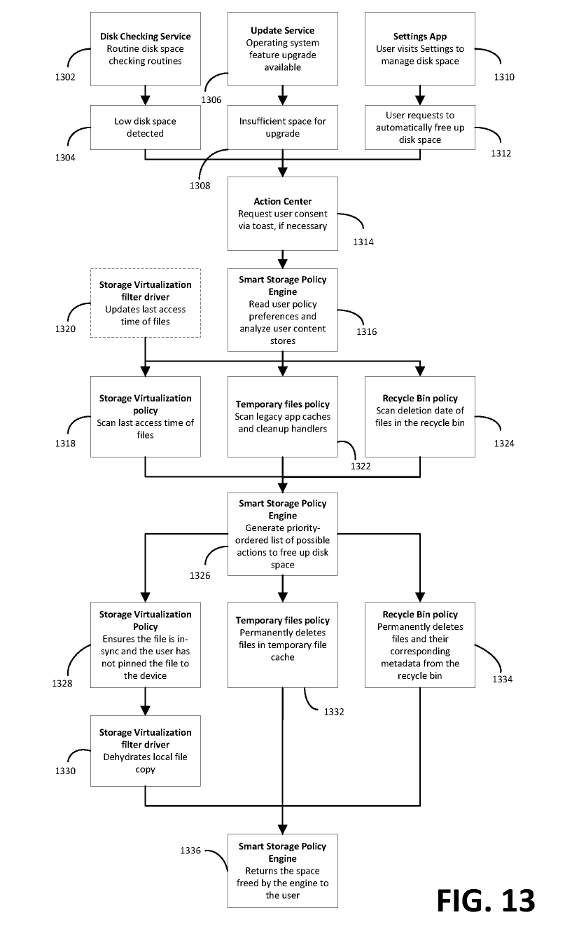

FIG. 13 is a block diagram illustrating a more detailed example of the process illustrated in FIG. 9, with possible entry points and triggers associated with the smart storage policy engine, in accordance with one embodiment.

In this example embodiment, the disk checking service module 1302 may perform routine disk space checking. For example, the disk checking service module 1302 may be configured to continuously monitor the amount of disk space available on the device. Alternatively, the disk checking service module 1302 may be configured to monitor the amount of disk space at certain intervals, or upon the occurrence of certain events, such as every time content is saved to local storage. At block 1304, the disk checking service module 1302 may determine that the device has entered a low storage state. One or more storage thresholds may be set for the amount of available disk space before triggering the one or more storage policies, as discussed above. For example, the threshold may be set at 2 GB of available storage, so that each time the amount of available storage on the computing device falls below 2 GB, the one or more storage policies may be executed by the policy engine.

In another embodiment, the update service module 1306 may determine that an update is being requested for the computing device. At step 1308, the update service module 1306 may further determine that the device lacks adequate storage to complete the upgrade successfully. For example, if the computing device runs on a Windows operating system, Windows Update can provide the exact space requirements needed for operating system (OS) upgrade staging.

In yet another example, the settings app 1310 may detect that a user of the device is visiting the smart storage policies landing page. Users looking to free up space can manually execute storage policies through the settings framework. At step 1312, the settings app 1310 may further detect that a user has modified the policy settings and wants to run them now. In this case, the policy engine may attempt to free up as much space as possible while still obeying user preferences.

In response to any of the triggers associated with steps 1302-1312, the action center module 1314 may be configured to obtain user consent to perform smart storage policy operations, if such consent has not been previously given, as shown at step 1314. As shown at step 1316, the smart storage policy engine may be further configured to read user policy preferences and analyze user content stores. Reading the user policy preferences may comprise analyzing the setting page associated with the settings app 1310.

The storage virtualization policy module 1318 may be configured to scan a last access time of files stored locally on the computing device. The storage virtualization filter driver 1320 may be configured to update a last access time of files. As discussed herein, the last access time of files may be updated, for example, if the user wishes to keep the file stored locally for a specified period of time. The temporary files policy engine 1322 may be configured to scan legacy application caches and cleanup handlers, while the recycle bin policy module 1324 may be configured to scan the deletion dates of files in the recycle bin.

After receiving input from the storage virtualization policy module 1318, the temporary files policy module 1322, and the recycle bin policy module 1324, the smart storage policy engine at step 1326 may be configured to generate a priority ordered list of possible actions in order to free up disk space. The amount of disk space to be freed may be determined by the smart storage policy engine or may be set by a user via the settings page.

Next, the storage virtualization policy module 1328 may ensure that the file is in-sync and the user has not pinned the file to the device, and the storage virtualization filter driver module 1330 may dehydrate the local file copy. In addition, the temporary files policy module 1332 may permanently delete files in the temporary file cache, and the recycle bin policy module 1334 may permanently delete files and their corresponding metadata from the recycle bin. Finally, the smart storage policy engine at step 1336 may return the space freed by the engine to the user.

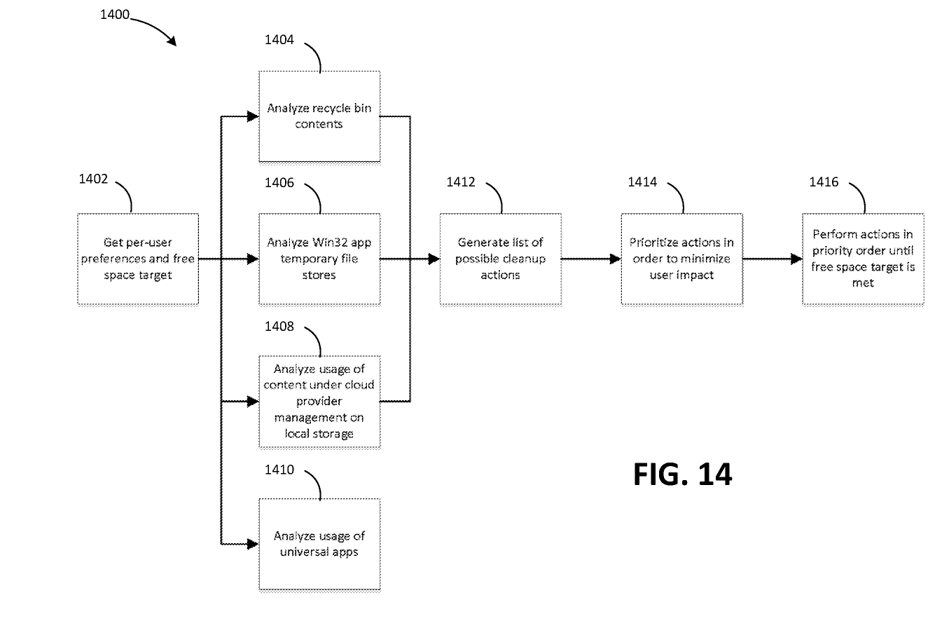

FIG. 14 illustrates is a flow diagram illustrating further details of the process illustrated in FIG. 10, in accordance with an embodiment. This example illustrates the policy engine analyzing the disk footprint of various system components and deciding which can be removed while staying within the boundaries of the user's preferences and minimizing the overall impact to user data.

As shown in step 1402, the policy engine may be configured obtain per-user preferences and determine a free space target. This free space target may be the storage threshold discussed above. The policy engine may also check to ensure that the user has opted into this functionality, for example, by a toast or via the settings page.

Next, the policy engine may analyze various components of the device, for example, Recycle Bin contents 1404, Win32 app temporary file stores 1406, usage of content under cloud provider management on local storage 1408, and usage of universal apps 1410.

After the analysis step, the policy engine may be configured to generate a list of possible cleanup actions that obey the user's preferences, as shown in step 1412. The list of possible cleanup actions may comprise permanently deleting certain content while dehydrating other content to remote storage. These lists may be merged to form the set of all valid actions that can be taken to free up space on the device.

At step 1414, the list of possible cleanup actions may be prioritized so that actions having the lowest user impact (e.g., “high priority” actions) are first in line to be executed. For example, “high priority” actions may comprise deleting temporary file caches and content stored in the Recycle Bin, and “low priority” actions may comprise dehydrating content and universal applications stored locally on the computing device. The content may only be deleted or dehydrated if it exceeds the age threshold specified in the one or more storage policies. In the example architecture illustrated in FIG. 4, the storage virtualization filter 204 may be responsible for ensuring that all files have an up-to-date access time.

Finally, once the actions are prioritized, the policy engine may be configured to perform the actions in priority order until the free space target is met, as shown in step 1418. The policy engine may keep track of the space freed by successful actions and continue executing until no actions remain or a user-provided free space target has been met.

In one embodiment, content may be shared among a number of users, and dehydration schemes may be dependent on the number of users that have access to the content. A particular type of content may be associated with one storage policy that specifies that the content may be dehydrated to remote storage after six months of nonuse by any of the users. For example, if the content was a type of financial data shared by an entire accounting department, even if User A has not used the file in eight months, the policy engine may determine to keep the file stored locally on User A's computer as long as User B has accessed the file on their computer within that six month timeframe.

The smart storage policy engine may be extensible. The priority of any given content may be determined by a user of the device, the smart storage policy engine, the cloud provider, or a combination of any of those.

The smart storage policy engine may also be configured to rehydrate content stored on the cloud back to the local storage. The policy engine may be configured to keep track of any dehydrated files when policies are executed, and may potentially rehydrate a subset or all of those files back to the local storage to give a user of the device the illusion that nothing has changed. For example, the smart storage policy engine may determine that content which was once classified as “high priority” content has become “low priority” content due to a change in circumstances, and should be brought back from the cloud to be stored locally. The smart storage policy engine may be configured to ensure that the content has been synced to the cloud before attempting to rehydrate it.

Any smart storage policy affecting files under management of a storage virtualization provider (e.g., cloud provider) may interact with third-party services and potentially cause increased network consumption if files are dehydrated due to a low storage scenario and then need to be rehydrated in the future by user request. Since these third party services are often used across multiple devices and platforms, they may have better contextual awareness as to whether a synced file is important to the user. In these cases, it may be ideal to keep a local copy of the file available to avoid user workflow impact and increased network/disk activity costs. Since the policy engine can only access usage information local to the current device, the cloud provider may be involved in the decision making process. To support this functionality, modifications to the application programming interfaces (APIs) of the cloud provider implementation and service identity registration contract may be made. These changes may allow cloud providers to declare that they would like to monitor and potentially veto any dehydration actions taken by the policy engine.

In one embodiment, if a cloud provider decides that content is important and should remain locally on the device, the storage virtualization implementation (e.g., the storage virtualization filter 204 in the example implementation of FIG. 4) may update the content's last access time to the current system time, ensuring another dehydration attempt on the file will not occur until the next time the age threshold for the content is reached. If the cloud provider wants to proactively prevent dehydration attempts on the file, it may also update the last access time independently. If the provider opts in to this functionality but its provided callback is unavailable or cannot make an informed decision (for example, due to network conditions), dehydration may continue to be blocked. If the provider does not opt in to this functionality, the policy engine may proceed as described above.

The illustrations of the aspects described herein are intended to provide a general understanding of the structure of the various aspects. The illustrations are not intended to serve as a complete description of all of the elements and features of apparatus and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The various illustrative logical blocks, configurations, modules, and method steps or instructions described in connection with the aspects disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the present disclosure.

The various illustrative logical blocks, configurations, modules, and method steps or instructions described in connection with the aspects disclosed herein, or certain aspects or portions thereof, may be embodied in the form of computer executable instructions (i.e., program code) stored on a computer-readable storage medium which instructions, when executed by a machine, such as a computing device, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any non-transitory (i.e., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computer.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

The description of the aspects is provided to enable the making or use of the aspects. Various modifications to these aspects will be readily apparent, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed:

1. A computing device comprising a processor and a memory, the computing device further comprising computer-executable instructions stored in the memory of the computing device which, when executed by the processor, cause the computing device to perform operations comprising:
detecting the occurrence of one or more of an amount of available storage on the computing device falling below a storage threshold, an update to the computing device requiring an amount of storage on the computing device that exceeds the amount of available storage, or user input comprising a request for storage on the computing device to be freed;
determining, in response to the detection, a need to free an amount of storage on the computing device; and
moving at least a portion of stored content on the storage of the computing device, based on at least one of a type of the stored content and an age of the stored content, to a remote store on a network to which the computing device is connected until the determined amount of storage on the computing device has been freed.

2. The computing device of claim 1, wherein moving at least a portion of the stored content to the remote store on the network comprises creating, on the storage of the computing device, a placeholder representing the at least a portion of stored content that has been moved to the remote store on the network.

3. The computing device of claim 2, wherein the placeholder comprises metadata associated with the at least a portion of stored content, a sparse data stream containing none or some data of the at least a portion of the stored content that is stored remotely, and information which enables the at least a portion of the stored content to be retrieved from the network.

4. The computing device of claim 1, the computer-executable instructions further causing the computing device, alternatively to or in addition to moving at least a portion of the stored content to the remote store on the network, delete at least a portion of the stored content.

5. The computing device of claim 1, wherein moving at least a portion of the stored content to the remote store on the network based on an age of the stored content comprises moving at least a portion of the stored content to the remote store on the network based on a last access time of the stored content.

6. The computing device of claim 5, wherein the stored content is shared by a plurality of users and the last access time of the stored content reflects a time the content was last accessed by any one of the plurality of users.

7. The computing device of claim 1, further comprising generating a list of stored content to be moved to the remote store on the network based on at least one of a type of the stored content and an age of the stored content.

8. The computing device of claim 7, further comprising prioritizing the list based on the type of the stored content and the age of the stored content.

9. The computing device of claim 1, further comprising obtaining user consent prior to moving the at least a portion of the stored content.

10. The computing device of claim 1, wherein moving the stored content to a remote store on a network to which the computing device is connected comprises moving first stored content to a first remote store and second stored content to a second remote store.

11. A method comprising:
detecting the occurrence of one or more of an amount of available storage on a computing device falling below a storage threshold, an update to the computing device requiring an amount of storage on the computing device that exceeds the amount of available storage, or user input comprising a request for storage on the computing device to be freed;
determining, in response to the detection, a need to free an amount of storage on the computing device; and
moving at least a portion of stored content on the storage of the computing device, based on at least one of a type of the stored content and an age of the stored content, to a remote store on a network to which the computing device is connected until the determined amount of storage on the computing device has been freed.

12. The method of claim 11, wherein moving at least a portion of the stored content to the remote store on the network comprises creating, on the storage of the computing device, a placeholder representing the at least a portion of stored content that has been moved to the remote store on the network.

13. The method of claim 12, wherein the placeholder comprises metadata associated with the at least a portion of stored content, a sparse data stream containing none or some data of the at least a portion of the stored content that is stored remotely, and information which enables the at least a portion of the stored content to be retrieved from the network.

14. The method of claim 11, further comprising, alternatively to or in addition to moving at least a portion of the stored content to the remote store on the network, deleting at least a portion of the stored content.

15. The method of claim 11, wherein moving at least a portion of the stored content to the remote store on the network based on an age of the stored content comprises moving at least a portion of the stored content to the remote store on the network based on a last access time of the stored content.

16. The method of claim 15, wherein the stored content is shared by a plurality of users and the last access time of the stored content reflects a time the content was last accessed by any one of the plurality of users.

17. The method of claim 11, further comprising generating a list of stored content to be moved to the remote store on the network based on at least one of a type of the stored content and an age of the stored content.

18. The method of claim 17, further comprising prioritizing the list based on the type of the stored content and the age of the stored content.

19. The method of claim 11, further comprising obtaining user consent prior to moving the at least a portion of the stored content.

20. The method of claim 11, wherein moving the stored content to a remote store on a network to which the computing device is connected comprises moving first stored content to a first remote store and second stored content to a second remote store.
